(19) United States
(12) Patent Application Publication
(10) Pub. No.: US 2009/0059747 A1
(43) Pub. Date: Mar. 5, 2009

(54) RECORDING CONDITION ADJUSTMENT METHOD FOR INFORMATION RECORDING MEDIUM AND INFORMATION RECORDING/REPRODUCING APPARATUS

(75) Inventors: Masaki Nakano, Tokyo (JP); Masatsugu Ogawa, Tokyo (JP); Shigeru Shimonou, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 11/817,464

(22) PCT Filed: Mar. 14, 2006
(86) PCT No.: PCT/JP2006/305006

§ 371 Date: Aug. 30, 2007

(30) Foreign Application Priority Data
Mar. 25, 2005 (JP) 2005-087436

(51) Int. Cl. G11B 20/00

(52) U.S. Cl. 369/47.15; G9B/20

(57) ABSTRACT

[PROBLEMS] To reduce the number of recording condition adjustment steps before information recording, simplify the recording condition adjustment procedure, and perform stable and accurate recoding condition adjustment of an information recording medium.

[MEANS FOR SOLVING PROBLEMS] When recording information on a recording medium, the recording condition is optimized. Next, under the optimized recording condition, a signal is recorded in a prescribed area of the information recording medium. Next, by using the signal recorded under the optimized recording condition, a part of the recording condition for the next and later is adjusted. Thus, a part of the recording condition is adjusted by using the signal recorded under the optimized recording condition and accordingly, it is possible to rapidly perform the recording condition adjustment before information recording.

### TECHNICAL FIELD

The present invention relates to a recording condition adjustment method for an information recording medium and an information recording/reproducing apparatus.

### BACKGROUND ART

With diversification of information, data volume is increasing in a storage field. Optical discs, which are recording media, have been undertaken so as to have larger capacity with high-density, that is, DVD is taking over CD. As for technical development approached toward high-density, a technique for recording a small mark exactly as much as possible, and a technique with which reproduction can be performed a near optical reproduction limitation have been developed. Accordingly, simply to say, an optical spot for recording/reproducing with smaller diameter is promoted by shorter wavelengths of LD light source and objective lens with high NA (NA: numerical aperture). Here, conventional DVD recordables will be described.

These optical discs has an area for calibrating recording power (PCA: Power Calibration Area) in a part of a disc space. Recording power is controlled (OPC: Optimum Power Control) by utilizing the area. In operations of the OPC, a reproducing of recorded signal after recording is performed with varying the recording power in multiple stages, so that test write learning is performed to obtain the recording power with which the reproducing can be performed optimally, as the optimal recording power. An optical disc device records actual data by using the recording power obtained at the time of the learning. Further, it is known that the optical disc device obtains high reliability by adopting a configuration for managing defect called Defect Management. That manages defect information in a data area to interpolate information of defected part by using information in a defect management area prior to recording information in the data area.

Concerning optimization of the recording power described above, a method for performing the recording condition adjustment by controlling the recording power with the OPC and controlling strategy for a recording waveform is disclosed, for example, in JP 2002-230770 (Patent Document 1). Also, JP 8-203081 (Patent Document 2) discloses a device in which recording information stored after test write learning is updated and stored at every learning in addition to recording information stored in advance (power, strategy), and which performs learning based on the information updated and stored.

As an index and a method for recording power control, a method for minimizing a reproduced signal jitter, a β method for obtaining a β value by inspecting asymmetry from reproduction amplitude of a long mark and reproduction amplitude of a short mark, and a γ method for determining a status by saturation degree of a recording mark amplitude are known.

Further, a system adopting a PRML (Partial-Response Maximum-Likelihood) technology (described later) has been in practical use in optical discs recorded with higher-density even more than DVDs. Jpn. J. Appl. Phys., Vol. 43, No. 7B (2004) & quot; Optimization of Write Conditions with a New Measure in High-Density Optical Recording” M. Ogawa et al. reports that recording power can be controlled by using PRSNR as SNR (signal-to-noise ratio) of a PR system in the above system. The PRSNR is reported in ISOM2003 (International Symposium Optical Memory 2003), Technical Digest pp. 164-165 & quot; Signal-to-Noise Ratio in a PRML Detection” S. OHKUBO et al. (pp. 164-165).

Next, recording condition in an optical disc device will be explained. The recording condition in the optical disc device includes a servo parameter such as focus including a tilt, track, aberration, and the like, in addition to the recording power and the strategy. Concerning to relative position relation between a disc surface and laser spot among the above, a focusing control is controlling the laser spot to follow vertical movement of a disc surface, and a tracking control is controlling the laser spot to follow radial movement (tracking movement) of a disc surface. In each of the controls, an optimal condition cannot be achieved only with an offset signal obtained from a head is simply adjusted to zero, but can be achieved with some amount of offset added thereto in many cases. Next, a tilt will be explained.

A tilt occurs between an optical disc and an optical head which reads out information from the optical disc because of disc warpage, which degrades beam quality. In order to detect the tilt, a system using a tilt sensor in which a disc surface is irradiated with an LED light so as to detect irregular distribution of reflective lights by a segmenting sensor, and a system in which jitter characteristic of a reproduced signal upon movement of a tilt is detected so as to obtain an optimal tilt angle exploratory with respect to a ROM in which data is recorded in advance are known. Further, JP2002-25090 (Patent Document 3) discloses that a tilt is detected with relating amplitude of a traverse signal and a tilt angle when a tracking servo is off.

Next, a PRML reproducing technology will be described. Conventionally, a slice identification system has been used to binarize data. This technique has adopted a method in which a reproduction waveform is filtered using an equalizer so as to reduce intersymbol interference. In this case, the equalizer usually suppresses the intersymbol interference, however, it increases noise components, and thereby it becomes difficult for recorded original data to be decoded from a reproduced signal when high-density recording is performed. On the other hand, the PRML (Partial-Response Maximum-Likelihood) is effective as a method for decoding data accurately when high-density recording is performed. In the PRML, a reproduction waveform is Partial-Response (hereinafter, it may be referred to as PR) equalized (PR equalization) into a waveform having intersymbol interference so as not to increase the noise component, Viterbi decoding (ML) is performed, and data is identified.

In a system with the PRML used, a reproduction signal is not assumed to be binary, but assumed to be three-value or more, that is, multi-value. Accordingly, PRML detection expecting the multi-value is different from the former case in that a recording/reproduction waveform is required to be suitable for the PRML detection. FIG. 4 shows examples of error rate measurements with varying pit lengths, using binary equalization by the conventional slice identification and using the PRML detection. In FIG. 4, broken lines indicates binary equalization, broken lines and dots indicates practically acceptable level, λ represents a laser wavelength of light source, and NA represents a numerical aperture of objective lens. FIG. 4 shows that a practically shortest pit length limit is about 0.35*λ/NA and error rate becomes worse remarkably when the pit length becomes shorter than that in the conventional binary equalization, and also shows that, by using the PRML detection, the reproduction is possible with shorter pit length than the above. In this regard, in accordance with the equation, 0.35*λ/NA, data can be recorded with the shortest pit length, about 0.2 μm pit length, when the light source wavelength is λ=405 nm, and the numerical aperture for objective lens NA is 0.65, for example.

Further, the present inventor presents a detecting unit which is corresponding to asymmetry in case of using the PRML detection in a preceding patent application (Patent Document 4).

Patent Document 1: JP 2002-230770 (pp. 3-4, FIG. 3)

Patent Document 2: JP 8-203081 (pp. 6-7, FIG. 2)

Patent Document 3: JP 2002-25090 (pp. 4-5, FIG. 3)

Patent Document 4: JP 2002-197660 (p. 5, FIG. 1)

Non-Patent Document 1: Jpn. J. Appl. Phys., Vol. 43, No. 7B (2004) “Optimization of Write Conditions with a New Measure in High-Density Optical Recording” M. Ogawa et al

### DISCLOSURE OF THE INVENTION

### Problems to be Solved by the Invention

As described above, according to the conventional art, a servo adjustment value adjusted in advance has been used, or detection has been performed appropriately for the servo parameter which varies a lot (for example, a focus offset and a tilt) so as to maintain recording quality.

However, the present inventor found that, when density of a recorded signal is increased to the degree that a signal quality can not measured by jitter directly, the servo parameter is desirably calibrated more optimal than one in the conventional art before information is recorded, for achieving the highest performance. For example, in tilt detection, a tilt is desirably detected and controlled more accurate compared to the detection using conventional traverse signal amplitude and using an LED, and similarly, as for a focus (hereinafter, referred to as Fo) offset, a track (hereinafter, referred to as Tr) offset, and aberration, it is desirable to be calibrated more accurate.

The above becomes remarkable in a case where parameters are out of an optimal value multiply, and there is a problem that calibration steps for the parameters are increased. For example, when both of the Fo offset and the tilt are out of the optimal multiply, the above described problem is obvious from a method where, either of them is fixed so as to optimize one parameter, and then the remaining parameter is optimized.

Therefore, calibration items before actual information recording becomes enormous compared with the conventional method, which causes a problem in which calibration time before recording increases a lot. In addition, in a case with the ROM medium and the like in which a signal is recorded in advance, the servo parameter can be optimized using a reproduced waveform of the recorded signal, on the other hand, in a case with a recordable recording medium with no signal recorded previously therein, that is, the case with the medium having an initial recording, a lot of steps are needed to record a recording signal with high-quality because of no recorded signal therein previously. Even if there is a recorded signal, it is not certain whether the quality of signal is guaranteed, and thereby there is a problem in which the signal cannot be used easily for calibration.

The present invention has been accomplished considering the above problems, and an exemplary object thereof is, with an optical disc device for recording/reproducing, to provide a recording condition adjustment method for an information recording medium and an information recording/reproducing apparatus for performing the recording method with which a recording condition learning step before information recording can be omitted, with which a recording condition adjustment procedure can be simplified more than one in the conventional art, and which can be performed with stability and high accuracy.

Another exemplary object of the present invention is to provide a recording condition adjustment method for an information recording medium in which an area including information which indicates usability for adjustment of recording condition is formed, and to provide an information recording/reproducing apparatus for performing the recording method.

Yet another exemplary object of the present invention is to provide a recording condition adjustment method for an information recording medium and an information recording/reproducing apparatus for performing the recording method with which a recording condition learning step before information recording can be omitted, with which a recording condition adjustment procedure can be simplified more than before, and which can be performed with stability and high accuracy, with respect to an optical disc device for recording/reproducing a mark or a space of which a shortest pit length is under 0.35*λ/NA, and to provide an information recording/reproducing apparatus for performing the recording method.

### Means for Solving the Problems

In order to solve the aforementioned problems, a recording condition adjustment method for an information recording medium according to the present invention includes: a step 1 in which a pre-recording learning is performed for optimizing a recording condition when information is recorded in a recording medium; a step 2 in which a signal is recorded in a prescribed area of the information recording medium under the optimal recording condition determined in the step 1; and a step 3 in which a part of the recording condition for the next or later is adjusted using the signal recorded with the optimal recording condition with which the recording is performed in the step 2.

Prior to the step 1, there may be a step 4 in which a recorded signal is searched in the prescribed area, and if there is a recorded signal in the prescribed area, the step 3 may be performed, while if there is no recorded signal in the prescribed area, the step 1 or 2 may be performed. Further, the step 3 may includes a step 3A in which a part of the recording condition to be controlled using the recorded signal is adjusted, and a step 3B in which a recording condition, which cannot be adjusted in the step 3A, is adjusted without using the recorded signal.

In order to adjust the recording condition in the step 3A, at least one of an amplitude value, an asymmetry value, an SNR value and an error rate may be used as an evaluation index upon adjustment with a recorded signal being read out. The recording condition may include any one of a focus offset, a tracking offset, a tilt or an aberration. Moreover, a part of a test area (a drive test zone or a disc identification zone) may be used as the prescribed area.

A signal recorded in the prescribed area may include information indicating the recorded signal itself can be used for adjusting the recording condition. The signal recorded in the prescribed area may include information indicating a drive in which the signal is recorded. As the information recording medium, one may be used in which spiral or concentric groove structure is formed in a radial direction periodically, in which a groove, a land in between the grooves, or both of them is/are being a recording/reproducing track, and in which the recording of the prescribed area in the step 2 is performed on a center track and at least one track each from right and left sides of the center track.

As the information recording medium, one may be used in which both of a groove and a land in between the grooves are being a recording/reproducing track, and in which the recording in the prescribed area is performed to a series of 6 tracks therein. The recording condition adjustment method may include a method for recording information optically by irradiating an optical beam from a laser light source focused by an objective lens on a surface of a recording medium, and the reproduction of the recorded signal may be performed such that the optical beam is irradiated on the recording medium surface so as to read out a mark and a space recorded on the recording medium by a reflective light from the recording medium surface as a recorded signal, and then a shortest value of a polarity inversion interval for the recorded signal on the recording medium may be set in smaller than 0.35*λ/NA, when a laser wavelength of the light source is λ, and a numerical aperture of the objective lens is NA.

An information recording/reproducing apparatus for performing the recording condition adjustment method for an information recording medium according to the present invention including a signal quality detecting section for estimating reproduced signal quality from a reproduced signal, recording condition control section for controlling the recording condition, and a learning processing section for performing a pre-recording learning which determines an optimal recording condition from the reproduced signal quality and the recording condition, the apparatus includes:

a recording control unit for performing a pre-recording learning for optimizing the recording condition when recording on information recording medium is performed, and producing a recording signal at a prescribed location based on information obtained by the learning processing section; and a control unit for reproducing a recorded signal produced by the recording control unit, and performing a part of a next or later recording condition adjustment processing.

Further, the apparatus may include: a searching processing unit for searching whether there is a recording signal or not in the prescribed area, prior to the pre-recording learning; and

a recording control unit for adjusting a part of the recording condition to be controlled using the recorded signal when the recorded signal exists in the prescribed area, performing the pre-recording learning processing when the recorded signal does not exist in the prescribed area, and recording a signal at a desired location based on information obtained by the learning processing section.

The adjustment processing using the recorded signal produced in the prescribed area may includes a first adjustment processing for adjusting a part of the recording condition to be controlled, and a second adjustment processing for adjusting the recording condition which cannot be adjusted by the first adjustment processing, without using the recording signal. The first adjustment processing may use at least one of an amplitude value, an asymmetry value, a SNR value or an error rate as an evaluation index upon adjustment with the recorded signal being read out. The recording condition may include any one of a focus offset, a tracking offset, a tilt or an aberration.

The prescribed area may be a part of a test area (a drive test zone or a disc identification zone). The signal recorded in the prescribed area may include information indicating a drive in which the signal is recorded. The information recording medium may be one in which a spiral or a concentric groove structure is formed in a radial direction periodically, in which a groove, a land in between the grooves, or both of them is/are being a recording/reproducing track, and in which recording in the prescribed area is performed to a series of 6 tracks.

The recording/reproducing apparatus may record information optically by irradiating an optical beam from a laser source after focusing the optical beam by an objective lens on a surface of a recording medium, the reproduction of the recorded signal may be performed with reading out a mark and a space recorded on the recording medium surface by a reflective light from the recording medium surface as a recorded signal by irradiating the optical beam on the recording medium surface, and a shortest value for a polar inversion interval of the signal recorded on the recording medium may be set in smaller than 0.35*λ/NA, when a laser wavelength of the light source is λ, a numerical aperture of the objective lens is NA.

### ADVANTAGEOUS EFFECTS OF THE INVENTION

A recording condition adjustment method for an information recording medium and an information recording/reproducing apparatus of the present invention achieves remarkable effects as follows.

A first effect of the present invention is that the recording condition adjustment before information recording can be performed at high speed. The reason is that there is a procedure in which a part of the recording condition is adjusted using a signal recorded under the recording condition adjusted optimally.

A second effect of the present invention is that the recording condition adjustment before information recording can be performed stably. The reason is that the recorded signal in the prescribed area includes information indicating its usability for the recording condition adjustment, which indicates that stability of the condition adjustment with respect to an apparatus is guaranteed.

A third effect of the present invention is that the recording condition adjustment before information recording is performed with high accuracy. The reason is that a plurality of tracks having a status similar to the status of actual information recording is used for the recording condition adjustment.

A fourth effect of the present invention is that the recording condition adjustment method before information recoding can be applied to an information recording medium including at least a lead-in/lead-out area. The reason is that an area in which a signal can be recorded freely by an apparatus, or an area in which a content of recording information can be selected uniquely for an apparatus, is used for a part of the recording condition adjustment.

Next, exemplary embodiments of the present invention will be explained with reference to drawings.

### EXEMPLARY EMBODIMENT 1

An information recording/reproducing apparatus (an optical disc device) according to an exemplary embodiment 1 of the present invention includes, as shown in FIG. 7, a signal quality detector (40) for estimating a reproduced signal quality from a reproduced signal, a recording condition control section (50) for controlling a recording condition, a learning processing section (50) for performing a pre-recording learning to determine an optimal recording condition from the reproduced signal quality and the recording condition as a fundamental structure, and the apparatus includes a recording control unit (50) for performing a pre-recording learning for optimizing the recording condition when recording on information recording medium is performed, and producing a recorded signal at a prescribed location in an information recording medium based on information obtained by the learning processing section, and a control unit (50) for reproducing a recorded signal produced by the recording control unit and performing a part of a next or later recording condition adjustment processing.

Next, the information recording/reproducing apparatus according to the exemplary embodiment 1 of the present invention will be explained in detail with reference to a specific example. The information recording/reproducing apparatus according to the exemplary embodiment 1 of the present invention includes, as shown in FIG. 7, at least an optical head (PUH; Pick UP Head) 10, a preamplifier 20, an A/D converter 21, an equalizer 22, a discriminator 30, a signal quality detector 40, a controller 50, and a servo information detector 70.

The controller 50 is configured with a computer, and a CPU of the computer executes a program recorded in a memory to perform functions of the recording condition control section for controlling a recording condition, the learning processing section for performing pre-recording learning to determine an optimal recording condition from the reproduced signal quality and the recording condition, the recording control unit for producing a recorded signal at a prescribed location in an information recording medium based on information obtained by the learning processing unit, and the control unit for reproducing the recorded signal produced by the recording control unit and performing a part of a next or later recording condition adjustment processing. Further, the controller 50 is configured so as to perform functions, prior to the pre-recording learning, of a search processing unit for searching whether there is a recorded signal in the prescribed area or not, and the recording control unit for adjusting a part of a recording condition to be controlled using a recorded signal when there is the recorded signal in the prescribed area, performing the pre-recording learning processing when there is no recorded signal in the prescribed area, and recording a signal at a desired location based on information obtained by the learning processing section.

The PUH 10 includes, as shown in FIG. 8, at least an objective lens 11, a laser diode (LD) 12, LD driving circuit 13, a light detector 14, a tilt information detector 15.

The PUH 10 shown in FIG. 7 is configured so as to be positioned accurately at a desired position in an optical disc 60 by a servomechanism. In this regard, the PUH 10 itself may be positioned with respect to the optical disc 20, and the objective lens 11 and the light detector 14, or the objective lens 11 only, shown in FIG. 8, may be positioned with respect to the optical disc 60. In order to positioning the PUH 10 with respect to the optical disc 60 by the servomechanism, controlling parameters are set respectively for positioning by fine motions and coarse motions in a radical direction of the optical disc 60, positioning in vertical direction of the optical disc 60, and detection/correction of a tilt regarding the optical disc 60 and the PUH 10. The servo information detector 70 detects servo information of the PUH 10 with respect to the optical disc 60, that is, information about positioning by fine motions and coarse motions in the radical direction of the optical disc 60, positioning in the vertical direction of the optical disc 60, and detection/correction of a tilt regarding the optical disc 60 and the PUH 10, and outputs a result thereof to the control 50. The controller 50 calculates the controlling parameters based on the servo information from the servo information detector 70, and positions the PUH 10 on the optical disc 60 based on the controlling parameters.

The LD driving circuit 13 of the PUH 10, as shown in FIG. 8, calibrates laser beam intensity outputted to the objective lens 11 by controlling the laser diode (hereinafter, referred to as LD) 12. The objective lens 11 irradiates the laser beam outputted from the LD 12 on a recording surface of the optical disc 60 when data is wrote in the optical disc 60, or when written data is read from the optical disc 60. The light detector 14 receives the laser beam reflected from the recording surface of the optical disc 60 through the objective lens 11, and reproduces data written in the recording surface of the optical disc 60, then outputs the reproduced signal to the preamplifier 20.

As shown in FIG. 8, a spindle driving circuit 18 is controlled by the controller 50 so as to rotate the optical disc 60. The tilt detector 15 of the PUH 10, as shown in FIG. 8, detects a tilt of the optical disc 60 and the PUH 10, and outputs the detected signal to the controller 50 as tilt information. In this regard, although FIG. 8 does not show, an unillustrated aberration calibration unit (a liquid crystal element or an aberration correction lens) is arranged at an optical path formed in between the LD 12 and the objective lens 11, and a laser beam shape from the LD 12 is corrected by the aberration calibration unit.

The LD driving circuit 13 of the PUH 10, as shown in FIG. 8, receives a reference clock signal and record binary data from an unillustrated write-in circuit, and also receives the recording condition (the parameter) from the controller 50 at the time of writing data on the recording surface of the optical disc 60, then controls the LD 12. Specifically, the LD driving circuit 13 converts the record binary data into a sequence signal in which at least two of 0 or 1 are successive in a sign bit sequence depending on a modulator with a minimum run length of 1, further converts the converted signal into a recording waveform in accordance with the recording condition from the controller 50, and controls the LD 12 based on the recording waveform to output an optical signal for write-in. When the LD 12 outputs the optical signal for write-in, the optical signal is irradiated on the recording surface of the optical disc 60 by the objective lens 11, and a mark is produced on the recording surface of the optical disc 60 by the irradiation with the optical signal, as shown in FIG. 6, then data is written on the recording surface of the optical disc 60.

As the optical disc 60, an optical disc with a guide groove is used. When data recording on the optical disc 60 starts, the controller 50 monitors occurrence of a predetermined interruptive condition for recording data, and if the interruptive condition for the data recording is realized, the data recording is interrupted, and controls the PUH 10 so as to reproduce data in an recorded area, including an area where the data recording is interrupted.

The preamplifier 20 amplifies, as shown in FIG. 7, a faint reproduced signal outputted from the light detector 14, and outputs the amplified reproduced signal to the A/D converter 21. The A/D converter 21 samples the reproduced signal from the preamplifier 20 with a certain frequency so as to convert the reproduced signal which is the analog signal into the reproduced signal which is the digital signal. The equator 22 converts the reproduced signal which is the digital signal outputted from the A/D converter 21 into a signal which includes PLL and synchronized with a channel clock, and at the same time, into an equalized and reproduced signal having a characteristic similar to PR (Partial-Response) (1,2,2,2,1) characteristic.

The discriminator 30 receives the equalized and reproduced signal from the equalizer 22, and selects the shortest path with respect to an Euclidean distance toward the equalized and reproduced signal, then outputs a sign bit sequence corresponding to the selected path as the decrypted binary data. In this regard, a Viterbi detector, for example, can be used for the discriminator 30.

The signal quality detector 40, as shown in FIG. 7, includes a PRSNR calculator, an asymmetry calculator, an error rate calculator, and an amplitude detector. The PRSNR calculator of the signal quality detector 40 calculates PRSNR (Partial Response Signal to Noise Ratio) based on the equalized and reproduced signal from the equalizer 22, and outputs its calculation result to the controller 50. The asymmetry calculator of the signal quality detector 40 calculates asymmetry based on the equalized and reproduced signal from the equalizer 22, and outputs its calculation result to the controller 50. In this regard, the asymmetry calculator uses the equalized and reproduced signal from the equalizer 22 as an input, however, the asymmetry calculator may calculates the asymmetry based on an output signal from the A/D converter 21.

The error rate calculator of the signal quality detector 40 calculates an error rate based on the equalized and reproduced signal from the equalizer 22, and outputs its calculation result to the controller 50. The amplitude detector of the signal quality detector 40 calculates amplitude based on an output signal from the A/D converter 21, and outputs its calculation result to the controller 50. The controller 50 sets an correction value based on tilt information outputted from the PUH 10 and the calculated information outputted from the signal quality detector 40, and corrects the recording condition (the parameters) by the correction value, then outputs it to the PUH 10 (the LD driving circuit 13).

Next, a case where the information recoding/reproducing apparatus according to the exemplary embodiment of the present invention shown in FIGS. 7 and 8 is operated will be explained with reference to a method shown in FIGS. 1 and 2. In the operation, the NA of the objective lens 11 in the PUH (an optical head) 10 is set in 0.65, a wavelength λ of the laser beam from the LD 12 is set as λ=405 mm, and a phase-change disc with a 0.6 mm substrate thickness is used as the optical disc 60 so as to perform recording/reproducing with respect to the optical disc 60 with a minimum bit length of 0.13 μm/bit at (1,7)RLL. Also, data is recorded/reproduced by ECC unit. In this regard, the information recording/reproducing apparatus according to the exemplary embodiment of the present invention does not operate only under the above mentioned condition, but also operates in like wise under conditions other than the above.

When the information recording/reproducing apparatus is loaded with the optical disc 60, the controller 50 controls the spindle driving circuit 18 to rotate the optical disc 60, and distinguishes a type of the optical disc 60 putted on. When the controller 50 determines that the optical disc 60 putted on is a recordable disc, the controller 50 controls the PUH 10 so as to move the PUH 10 to a prescribed location with respect to the optical disc 60, and searches whether there is a Reference-Zone or not in the optical disc 60 by the PUH 10. In this case, the servo parameter to move the PUH 10 is calibrated in a degree with which the Reference-Zone can be detected. Next, cases will be explained separately where the Reference-Zone exists in the optical disc 60, and where the Reference-Zone does not exist in the optical disc 60.

In the case where the Reference-Zone is not in the optical disc 60, the controller 50 detects a correspondence relation between a tracking error signal amplitude and a tilt with varying the tilt of the PUH 10 with respect to the optical disc 60 based on the information of the servo information detector 70, and selects and sets a Fo offset and a tilt with which the tracking error signal amplitude becomes maximum.

Next, the controller 50 controls the PUH 10 to move to a drive test zone which is in an area of the optical disc 60, and controls the light detector 14 of the PUH 10, the preamplifier 20, the A/D converter 21, the equalizer 22, the discriminator 30, and the signal quality detector 40 so as to determine an area without a signal recorded in the optical disc. After determining, the controller 50 performs coarse calibration with respect to intensity of the laser beam, that is, a recording power at the time of data recording, outputted from the LD 12. Namely, the controller 50 records data on the optical disc by the PUH 10 with varying the recording power, reproduces the recorded signal by the PUH 10, and calculates each of asymmetries by the signal quality detector 40 based on the reproduced signal, then determines an optimal recording power condition from a correlative relationship between the asymmetry and the recording power condition, at the same time, detects a power margin. In this case, the controller 50 sets a varying range of the recording power from −20% to +20% centering a parameter of the recording power of the PUH 10, especially of the LD 12, and varies it by 10% unit. That is to say, the recording power is varied at +20%, +10%, 0%, −10%, and −20%.

Following the above, the controller 50 lowers the recording power under a determined optimal recording power, and performs recording in a continuing area of the data recorded area with varying a tilt of the PUH 10 with respect to the optical disc 60, then controls a recorded signal for reproduction. In this case, the controller 50 selects a setting of the tilt, with which amplitude calculated by the amplitude detector of the signal quality detector 40 becomes maximum, as a tilt correction value.

Following the above, the controller 50 calibrates the Fo offset upon recording. That is, the controller 50 lowers a recording power under the determined optimal recording power, and controls for recording data with varying a Fo offset amount in + and − directions centering the optimal point of the coarse calibration. At that time, the controller 50 selects an optimal condition for the Fo offset upon recording taking a PRSNR calculated by a PRSNR circuit of the signal quality detector 40 as a measure for each Fo offset condition. As for the calibration of the Fo offset, for example, variation is performed in a rage from −0.2 μm to +0.2 μm by 0.05 μm step.

Next, the controller 50 performs control for precise calibration of the recording power upon recording data on the optical disc 60. That is, the controller 50 records data with varying the recording power by a 5% step in a range from −15% to +15% centering on the recording power which is obtained by the recording power coarse calibration, that is, varying at −15%, −10%, −5%, 0%, +5%, +10%, +15% by a 5% unit centering on the power obtained by the recording power coarse calibration. Then, the controller 50 controls to reproduce the recorded data. At that time, the controller 50 selects the optimal recording power based on the recording power and the PRSNR calculated by the PRSNR circuit in the signal quality detector 40 on the basis of the reproduced signal.

Following the above, the controller 50 controls the PUH 10 to move to the prescribed drive test zone area on the optical disc 60, and controls to form the Reference-Zone in the drive test zone under the recording condition with optimal recording power. The area formed then corresponds to at least about one circuit of the disc, and a recording mark is produced so that a center track and one track each at the right and left sides of the center track are recorded. Further, information including a drive ID (a drive manufacturer name, a drive model name, a type number, and a unique number for a device) can be used then. The information can indicate that usability for the recording condition adjustment. In addition, the drive ID can be recorded in the disc identification zone, too.

When there is the Reference-Zone, the controller 50 performs tilt calibration of the PUH 10 and Fo offset calibration of the PUH 10 with respect to the optical disc 60 sequentially. In this case, upon variation of the tilt of the PUH 10 to the optical disc 60, the controller 50 controls to reproduce data in the Reference-Zone with varying a status with a multiple combination by which the Fo offset condition of the PUH 10 is varied, and selects an optimal tilt condition, an optimal Fo offset condition taking the PRSNR calculated by the PRSNR circuit of the signal quality detector 40 as an index. In this case, the controller 50 may select the optimal tilt condition and the optimal Fo offset condition taking an error rate calculated by the error rate calculator of the signal quality detector 40 as an index.

Next, the controller 50 controls to record data with varying the recording power by a 5% step in the range from −15% to +15%, that is, at −15%, −10%, −5%, 0%, +5%, +10%, +15%, centering on the parameter of the recording power included in the LD 12 under the tilt and the Fo offset conditions obtained by reproduction of data in the Reference-Zone. Then, the controller 50 controls to reproduce the recorded data, and selects the optimal recording power based on the PRSNR, calculated by the PRSNR circuit of the signal quality detector 40 on the basis of the reproduced signal, and the recording power. In accordance with the above process, the information recording/reproducing apparatus according to the present invention can be achieved high-speed, highly accurate, and stable adjustment for the recording condition.

In this regard, as an area capable of forming the Reference-Zone in a HD-DVD rewritable medium, FIG. 9 shows an example of an area structure of the drive test zone in the disc, and an area structure in a case with an area of a disc identification zone and a defect management area included. The disc identification zone and the defect management zone can be utilized as a part of the Reference-Zone. Further, an area other than an area predetermined as a user data area or a specific management information area (for example, a boundary area in a recording medium in which a surface is separated into a plurality of areas) can be utilized as the Reference-Zone.

Further, the present invention can be applied to formatting, in particular, for both of a Land/Groove structure disc or an In-Groove/On-Groove structure disc. Moreover, an area guaranteed as an area recorded under the optimal condition is utilized for a part of recording adjustment, and thereby the present invention can be applied not only to a single-layer of a disc layer structure, but also to a multiple-layer structure such as a double-layer and a triple-layer as well.

### EXEMPLARY EMBODIMENT 2

Next, a method for adjusting the recording condition when data is recorded on the surface of the optical disc 60 using the above mentioned information recording/reproducing apparatus will be explained.

A recording condition adjustment method for an information recording medium according to an exemplary embodiment 2 of the present invention is established, as shown in FIG. 1A for performing each processing of a pre-recording learning processing step A100, a step of recording processing under an optimal recording condition A200, and a recording condition adjustment processing step A300. The pre-recording learning processing step A100 includes, as shown in FIG. 1B, a tilt coarse calibration processing step A110, a Fo coarse calibration processing step A120, a recording power coarse calibration processing step A130, a tilt correction processing step A140, a step of Fo calibration processing on recording A150, and a recording power precise calibration processing step A160.

In the tilt coarse calibration processing step A110 shown in FIG. 1A, a tilt with respect to the optical disc 60 being a kind of the information recording medium and the PUH 10 for reading out/writing in data from/to the optical disc 60 is varied under control of the controller 50, at the same time, a correspondence relation between a tracking error signal amplitude and the tilt and the PRSNR are measured by the amplitude detector and the PRSNR detector of the signal quality detector 40, and a tilt value with which the tracking error signal amplitude becomes maximum is set by the controller 50. Referring to a measurement result of the correspondence relation between the tracking error signal amplitude and the tilt by the amplitude detector and the PRSNR detector of the signal quality detector 40 in the FIG. 10 for example, a neighborhood of maximum tracking error signal amplitude corresponds to the optimal PRSNR which is an performance indication. Further, the tilt detection by a tilt sensor has the same effect.

Using the optimal setting by the tilt coarse calibration, in the Fo coarse calibration processing step A120, the PUH 10 is controlled by the controller 50, and thereby a correspondence relation between a tracking error signal amplitude and a Fo offset is measured with varying the Fo offset by the amplitude detector of the signal quality detector 40, and the Fo offset value with which the tracking error signal amplitude becomes maximum is set by the controller 50. Using the setting by the tilt coarse calibration and the Fo coarse calibration, in the recording power coarse calibration processing step A130, the recording power by the PUH 10 is varied under the control of the controller 50, at the same time, data is recorded on the optical disc 60 using the PUH 10, and the recorded data is reproduced by the PUH 10, then the asymmetry is calculated by the asymmetry detector of the signal quality detector 40 based on the reproduced signal. The controller 50 determines the optimal recording power condition from the correlation between each of the recording power conditions and each of the asymmetries. In this regard, as initial recording power, a recording power value included in the PUH 10 in advance, or recording power information provided in advance on the optical disc 60, is used.

In the tilt correction processing step A140, the PUH 10 is controlled by the controller 50, and the power is lowered under the optimal recording power condition, then performs recording with varying a tilt with respect to the optical disc 60 and the PUH 10 centering the tilt coarse calibration optimal point obtained by the tilt coarse calibration in the tilt coarse calibration processing step A110, and in addition, performs reproduction operation to a signal recorded, and then a tilt correction value with respect to the optical disc 60 and the PUH 10 with which the recorded and reproduced signal amplitude becomes maximum is obtained by the controller 50. In this regard, the recording power lowered under the optimal recording power condition is preferably in the approximately lowest value in the power margin, and a step size to vary the tilt is preferably smaller than a step size of the coarse calibration.

Using the tilt angle selected by the tilt correction, in the step of the Fo calibration processing upon recording A150, the power is lowered more than the optimal recording power condition as well as the recording power in the tilt correction processing step A140, and the PUH 10 is controlled by the controller 50, and thereby data is recorded on the optical disc 60 with Fo offset amount varied in the + and − directions centering the coarse calibration optimal point. The recorded data is reproduced, and the PRSNR is measured by the PRSNR calculator of the signal quality detector 40 based on the reproduced signal. Next, the optimal condition for the recording Fo is selected by the controller 50 taking the PRSNR as a measure for each of the Fo offset conditions. At that time, calibration is performed in a calibration range from −0.2 μm to +0.2 μm by 0.05 μm step.

Next, using the condition selected by the tilt correction and the Fo calibration on recording, the recording power precise calibration processing step A160 is performed. In the recording power precise calibration processing step A160, the PUH 10 is controlled by the controller 50 so that data is recorded on the optical disc 60 with varying the recording power by more precise step size centering the power obtained by the recording power coarse calibration processing step A130. Next, the recorded data is reproduced, and the PRSNR is measured by the PRSNR calculator of the signal quality detector 40 based on the reproduced signal, and optimal recording power is selected by the controller 50 from each of the recording power conditions and each of the PRSNRs derived from the reproduced signal which is reproduced from the recorded signal.

In this regard, performing order of the tilt coarse calibration processing step A110, the Fo coarse calibration processing step A120, and the recording power coarse calibration processing step A130 is not limited by the present exemplary embodiment, the same effect can be obtained with another order. The order of the tilt correction processing step A140 and the step of the Fo calibration processing on recording A150 can be also changed to obtain the same effect. Further, calibration items do not need to be limited by the present exemplary embodiment, and calibration items can be changed to obtain the same effect only in a procedure with which the optimal recording condition can be selected.

In the step of the recording processing under the optimal recording condition A200, recording is performed in a desired area (hereinafter, referred to as Reference-Zone) under the optimal recording condition derived in the pre-recording learning processing step A100. The area formed at that time corresponds to at least about one circle of the optical disc, and in a case with the In-Groove (as well as the On-Groove or On-Land) structure disc, as shown in FIG. 5, a recording mark is preferably produced so that the center track and at least one track each from the right and the left sides of the center track are recorded. In the recording condition adjustment processing step A300, a part of the next or later recording condition adjustment is performed using the Reference-Zone. Here, the next or later recording condition adjustment means that cases where an optical disc is taken out from the device and is put into the device again so as to record information, and where recording condition adjustment operation before information recording operation is performed again depending on some condition, such as temperature change or device status change, even if the optical disc is not taken out. The recording condition adjustment step processing step A300 further includes configuration for performing each processing of the tilt calibration processing step A310, the Fo calibration processing step A320, the recording power calibration processing step A330.

In the tilt calibration processing step A310, data recorded in the Reference-Zone is reproduced with varying the tilt condition of the PUH 10 with respect to the optical disc 60. The PRSNR is measured by the PRSNR calculator of the signal quality detector 40 based on the reproduced signal, and the optimal tilt condition is selected by the controller 50 taking the PRSNR as an index. In the Fo calibration processing step A320, using a setting selected in the tilt calibration processing step A310, the PUH 10 is controlled by the controller 50, thereby the Fo offset is varied, and the data in the Reference-Zone is reproduced, then the PRSNR is measured by the PRSNR calculator of the signal quality detector 40 based on the reproduced signal. The optimal Fo offset condition is selected by the controller 50 taking the PRSNR as an index.

In the recording power calibration processing step A330, the recording power by the PUH 10 is varied using the conditions selected in the tilt calibration processing step A310 and the Fo calibration processing step A320, and data is recorded on the optical disc 60, then the recorded data is reproduced. The PRSNR is measured by the PRSNR calculator of the signal quality detector 40 based on the reproduced signal, and the optimal recording power is selected by the controller 50 from each of the recording power conditions and each of the PRSNRs derived from the reproduced signal which is reproduced from the recorded signal.

In this regard, the recording power by the PUH 10 is varied according to a unit of recording, for example, setting 64 KB as one ECC block, and setting 7 segments of one ECC blocks as one unit, with respect to data after being recording modulated whose run length is limited.

The tilt coarse calibration and the Fo coarse calibration are affecting each other even if either of them is optimal, so that each of the calibration operation may be repeated alternately, like switchbacking. Namely, for example, when there is a plurality of parameters, an operation in which one parameter is fixed while another parameter is calibrated optimally is repeated. In addition, an order of the tilt calibration processing step A310 and the Fo calibration processing step A320 are not limited by the above, and can be changed to obtain the same effect.

The tilt coarse calibration and the Fo coarse calibration may be performed when the apparatus is loaded with the information recording medium, if they are not performed on the pre-recording learning.

In this regard, the aberration can be calibrated accordingly in the above series of operations. For example, an aberration amount is varied by the aberration calibration unit placed on an optical path formed in between the LD 12 and the objective lens 11, and at the same time the data is recorded on the optical disc 60, then the data is reproduced. The PRSNR and the error rate are measured by the PRSNR calculator and the error rate calculator of the signal quality detector 40 based on the reproduced signal. The optimal aberration is determined by the controller 50 with the PRSNR or the error rate. In addition, when the Reference-Zone exists in advance, by measuring the signal quality with varying the aberration amount, the optimal aberration setting can be selected.

### EXEMPLARY EMBODIMENT 3

Next, a recording condition adjustment method for an information recording medium according to an exemplary embodiment 3 of the present invention will be explained. In the recording condition adjustment method of the information recording medium according to the exemplary embodiment 3 of the present invention, a recording condition is adjusted using the aforementioned information recording/reproducing apparatus when data is recorded on the surface of the optical disc 60.

a fundamental structure of the recording condition adjustment method for the information recording medium according to the exemplary embodiment 3 of the present invention has a commonality with the method according to the exemplary embodiment 2, however, the recording condition adjustment method of the information recording medium according to the exemplary embodiment 3 of the present invention is devised more in a point in which a recording signal searching processing step B000 is performed prior to the pre-recording learning. FIGS. 2A-2C show flowcharts of the recording condition adjustment method for the information recording medium according to the exemplary embodiment 3 of the present invention. The recording condition adjustment method for the information recording medium according to the exemplary embodiment 3 includes a structure for performing each processing in a recording signal searching processing step B000, a pre-recording learning processing step B100, a step of recording processing under an optimal recording condition B200, and a recording condition adjustment processing step B300.

In the recording signal searching processing step B000, an area recorded under the optimal condition (the Reference-Zone) is searched, or whether there is the Reference-Zone or not is searched. For example, amplitude of a longest mark/space may be detected (detected by a peak hold or a bottom hold of the reproduced signal using an analog technique, or by numerical calculation of a signal read in using a digital technique) so as to detect no amplitude variation in an approximately constant rate, and besides, so as to detect whether there is an area or not in which amplitude detected by using the longest mark/space (about for one circle of the track) or a specific length or longer mark/space is approximately constant. Further, if a reproducing condition is adjusted in advance such that information can be read, information usable for the recording condition adjustment or information indicating the drive ID (a drive manufacturer, a drive model name, a type number, a unique number of an apparatus) can be detected. In addition, when the structure is to perform defect management, a defect management area in which a signal is recorded accurately can be utilized as a part of the adjustment area.

If there is the Reference-Zone, the recording condition adjustment processing step B300 is performed. The recording condition adjustment processing step B300 has a structure for performing each processing further of the tilt calibration processing step B310, the Fo calibration processing step B320, the recording power calibration processing step B330.

In the tilt calibration processing step B310, data in the Reference-Zone is reproduced with varying a tilt condition of the PUH 10 with respect to the optical disc 60. The PRSNR is measured by the PRSNR calculator of the signal quality detector 40 based on the reproduced signal, and the optimal tilt condition is selected by the controller 50 taking the PRSNR as an index. In the Fo calibration processing step B320, using the condition selected in the tilt calibration processing step B310, the PUH 10 is controlled by the controller 50, thereby the Fo offset is varied, and at the same time, the data in the Reference-Zone is reproduced. The PRSNR is measured by the PRSNR calculator of the signal quality detector 40 based on the reproduced signal, and the optimal Fo offset condition is selected by the controller 50 taking the PRSNR as an index. At that point, the optimal conditions of the tilt and the Fo offset are determined, and each parameter is set.

The recording power calibration processing step B330 is performed using the conditions adjusted in the tilt calibration processing step B310 and the Fo calibration processing step B320. In the recording power calibration processing step B330, the PUH 10 is controlled by the controller 50, thereby the recording power of the PUH 10 is varied, and at the same time, data is recorded on the optical disc 60. The recorded data is reproduced, and the PRSNR is measured by the PRSNR calculator of the signal quality detector 40 based on the reproduced signal. Then, the optimal recording power is selected by the controller 50 from each of the recording power conditions and each of the PRSNRs derived from the reproduced signal which is reproduced from the recorded signal. Here, the order of the tilt calibration processing step B310 and the Fo calibration processing step B320 is not limited, and the same effect can be obtained with another order.

If there is no Reference-Zone, each processing in the pre-recording learning processing step B100, the step of the recording processing under the optimal recording condition B200, and the recording condition adjustment processing step B300 are performed. The pre-recording learning processing step B100 has a structure for performing further each of processing in the tilt coarse calibration processing step B110, the Fo coarse calibration processing step B120, the recording power coarse calibration processing step B130, the tilt correction processing step B140, the step of the Fo calibration processing on recording B150, and the recording power precise calibration processing step B160.

In the tilt coarse calibration processing step B110, the tilt of the PUH 10 with respect to the optical disc 60 is vaired by the controller 50, at the same time, a correspondence relation between a tracking error signal amplitude and the tilt is measured by the signal quality detector 40, and a tilt value with which a tracking error signal amplitude becomes maximum is set by the controller 50. In addition, the tilt value may be detected by the tilt sensor. In the Fo coarse calibration processing step B120, using the tilt condition selected by the tilt coarse calibration step B110, the PUH 10 is controlled by the controller 50, thereby the Fo offset is varied, and at the same time, a correspondence relation between a tracking error signal amplitude and the Fo offset is measured by the signal quality detector 40, then the Fo offset value with which the tracking error signal amplitude becomes maximum is set by the controller 50.

The recording power coarse calibration processing step B130 is performed using the conditions selected in the tilt coarse calibration processing step B110 and the Fo coarse calibration processing step B120. In the recording power coarse calibration processing step B130, the PUH 10 is controlled by the controller 50, thereby the recording power by the PUH 10 is varied, and at the same time, data is recorded on the optical disc 60, then the data is reproduced. The asymmetry is measured by the signal quality detector 40 based on the reproduced signal, and the optimal recording power condition is determined by the controller 50 from a correlation between each of the recording power conditions and each of the asymmetries derived from the reproduced signal which is reproduced from the recorded signal.

In the tilt correction processing step B140, the PUH 10 is controlled by the controller 50, and thereby the recording power is lowered under the optimal recording power condition, and the tilt of the PUH 10 with respect to the optical disc 60 is varied by smaller step size than the step size at the time of the coarse calibration centering the optimal tilt obtained in the tilt coarse calibration processing step B110, at the same time, data is recorded on the optical disc 60, and the recorded data is reproduced. The tilt correction value with which the recorded and reproduced signal amplitude becomes a maximum is obtained by the controller 50 based on the tilt information outputted from the PUH 10. In this regard, the recording power lowered under the optimal recording power condition is preferably the approximate lowest value in the usual power margin.

After the tilt condition selected in the tilt correction processing step B140 is set, in the step of the Fo calibration processing on recording B150, the PUH 10 is controlled by the controller 50 as well as the power in the tilt correction processing step B140, and thereby the recording power by the PUH 10 is lowered under the optimal recording power condition, also the PUH 10 is controlled by the controller 50 so as to vary the Fo offset amount in the +and − directions centering the coarse calibrated optimal point, at the same time, data is recorded on the optimal disc 60, and then the recorded data is reproduced. The PRSNR is measured by the signal quality detector 40 based on the reproduced signal, and the Fo optimal condition on recording is selected by the controller 50 taking the PRSNR as a measure for each Fo offset condition.

The recording power precise calibration processing step B160 is performed using the conditions selected in the tilt correction processing step B140 and the step of Fo calibration processing on recording B150. In the recording power precise calibration processing step B160, the recording power of the PUH 10 is varied by a more precise step size centering the recording power obtained in the recording power coarse calibration processing step B130, and at the same time, data is recorded on the optical disc 60, then the data is reproduced. The PRSNR is measured by the PRSNR calculator of the signal quality detector 40 based on the reproduced signal, and the optimal recording power is selected by the controller 50 from each of the recording power conditions and each of the PRSNRs derived from the reproduced signal which is reproduced from the recorded signal.

In this regard, order of the tilt correction processing step B140 and the step of the Fo calibration processing on recording B150 can be changed to obtain the same effect. Further, calibration items are not limited by the present exemplary embodiment, and also the content of embodiment is not limited as long as the recording condition can be adjusted optimally.

In the recording processing step B200 under the optimal recording condition, data is recorded in the Reference-Zone under the optimal recording condition derived in the pre-recording learning processing step B100. Further, information of the recording signal on recording under the optimal recording condition may be a drive ID (a drive manufacture name, a drive model name, a type number, a unique number of an apparatus).

Later procedures are the same as the one in the case where the Reference-Zone exists. In addition, a case where the recording condition is required to be adjusted because of taking out a disc, re-loaded with a disc, and device environment change (temperature change and elapse of a certain time) is included in between the step of the recording processing under the optimal recording condition B200 and the recording condition adjustment processing step B300.

As described, this exemplary embodiment adopts a configuration in which a recording signal is searched prior to the pre-recording learning, a recording condition can be adjusted at high speed and stably. Further, the drive ID (a drive manufacture name, a drive model name, a type number, a unique number of an apparatus, etc.) is used as information, and thereby a recording signal is determined its quality and reliability, so stable and accurate adjustment can be also achieved.

Further, in a case with a structure where the defect management is performed, a signal is of high quality and reliable in the defect management area, so that stable and accurate adjustment can be achieved if it is utilized in a part of the calibrations, and besides, high speed adjustment can be achieved because it is read out in a primary phase of the apparatus operations.

### EXEMPLARY EMBODIMENT 4

Next, a recording condition adjustment method for an information recording medium according to an exemplary embodiment 4 of the present invention will be explained with reference to FIGS. 3A-3C. Even in the recording condition adjustment method for the information recording medium according to the exemplary embodiment 4 of the present invention, the aforementioned information recording/reproducing apparatus is used to adjust the recording condition of the optical disc 60 when data is recorded on the recording surface thereof.

A fundamental structure of the recording condition adjustment method for the information recording medium according to the exemplary embodiment 4 of the present invention has a commonality with the one in the exemplary embodiment 2, however, the recording condition adjustment method for the information recording medium according to the exemplary embodiment 4 of the present invention is contrived particularly for a Land/Groove structure disc introducing a De-track correction into the pre-recording learning processing step A100. The pre-recording learning processing step A100 has a structure for performing each processing in the tilt coarse calibration processing step A110, the Fo coarse calibration processing step A120, the recording power coarse calibration processing step A130, the tilt correction processing step A140, the step of Fo calibration processing on recording A150, the recording power precise calibration processing step A160, and the De-track correction processing step A170.

In the tilt coarse calibration processing step A110, the tilt of the PUH 10 with respect to the optical disc 60 is varied under the control of the controller 50, at the same time, a correspondence relation between a tracking error signal amplitude and the tilt is measured by the signal quality detector 40, and the tilt value with which the tracking error signal amplitude becomes maximum is set by the controller 50. For example, as shown in FIG. 10, a measurement result of the correspondence relation between the tracking error signal amplitude and the tilt by the amplitude detector and the PRSNR detector of the signal quality detector 40 shows that a neighborhood of the maximum tracking error signal amplitude corresponds to the optimal PRSNR which is a performance index.

Using the selected condition in the tilt coarse calibration processing step A110, in the Fo coarse calibration processing step A120, the PUH 10 is controlled by the controller 50, thereby the Fo offset is varied, and at the same time, a correspondence relation between a tracking error signal amplitude and the Fo offset is measured by the signal quality detector 40, then a Fo offset value with which the tracking error signal amplitude becomes maximum is set by the controller 50. The recording power coarse calibration processing step A130 is performed using the conditions selected in the tilt coarse calibration processing step A110 and the Fo coarse calibration processing step A120. In the recording power coarse calibration processing step A130, the recording power by the PUH 10 is varied by the controller 50, and at the same time, data is recorded on the optical disc 60, then the recorded data is reproduced. The asymmetry is measured by the signal quality detector 40 based on the reproduced signal, and the optimal recording power condition at the coarse calibration is determined by the controller 50 from the correlation relation between each of the recording power conditions and each of the asymmetries derived from the reproduced signal which is reproduced from the recorded signal.

In the tilt correction processing step A140, the PUH 10 is controlled by the controller 50, thereby the recording power is lowered under the optimal recording power condition of the coarse calibration, the tilt of the PUH 10 with respect to the optical disc 60 is varied centering the tilt coarse calibration optimal point selected in the tilt coarse calibration processing step A110, and at the same time, data is recorded on the optical disc 60, then the recorded data is reproduced. The amplitude of the reproduced signal is measured by the signal quality detector 40 based on the reproduced signal. The controller 50 obtains the tilt correction value with which the recorded and reproduced signal amplitude becomes maximum based on tilt information outputted from the PUH 10 and amplitude information of the reproduce signal. In this regard, the recording power to be lowered under the optimal recording power condition is preferably an approximate lowest value in the power margin. Also, the condition selected by the Fo coarse calibration in the processing step A120 is used for the Fo offset.

Using the tilt condition selected in the tilt correction processing step A140, in the step of the Fo calibration processing on recording A150, power is lowered under the optimal recording power condition as well as the recording power in the tilt correction processing step A140, the PUH 10 is controlled by the controller 40, thereby the Fo offset amount is varied in the + and − directions centering the coarse calibration optimal point, and at the same time, data is recorded on the optical disc 60, then the recorded data is reproduced. The PRSNR is measured by the signal quality detector 40 based on the reproduced signal, and the optimal condition of the Fo on recording is selected by the controller 50 taking the PRSNR as a measure for each of the Fo offset conditions. Then, the calibration is performed in a range from −0.2 μm to +0.2 μm, by 0.05 μm step.

The recording power precise calibration processing step A160 is performed using the selected conditions in the tilt correction processing step A140 and the step of the Fo calibration processing on recording A150. In the recording power precise calibration processing step A160, the recoding power is varied by more precise step size centering the recording power obtained in the recording power coarse calibration processing step A130, and at the same time, data is recorded on the optical disc 60, then the recorded data is reproduced. The PRSNR is measured by the signal quality detector 40 based on the reproduced signal, and the optimal recording power is selected by the controller 50 from each of the recording power conditions and each of the PRSNRs derived from the reproduced signal which is reproduced from the recorded signal. In this regard, the above operation is performed for a Land track and a Groove track respectively.

In the De-Track correction processing step A170, the PUH 10 is controlled by the controller 50, thereby a recording mark is produced on the center track of the optical disc 60, and after that, data is recorded while the Tr (track) offset is varied toward the both neighboring tracks, then the offset value with which the PRSNR becomes the optimal condition for the center track is selected by the controller 50. At that time, the recording power for recording on both of the neighboring is preferably an approximate maximum value in the power margin, and as for combination of varying conditions for the Tr (track) offset, the off tracking amount of the center track and the neighbor tracks on the optical disc has desirably about 9 variations, which is 3*3 variations, as shown in FIG. 11 for example. For example, the left below of FIG. 11 (−5, +5) indicates a condition in which the off tracking amount of the center track is −5%, and the off tracking amount of the both neighboring tracks is +5%.

In this regard, the Tr (track) offset is varied by a specific unit, for example, it can be varied in a several pattern during one circle of the disc.

In the step of the recording processing under the optimal recording condition A200, data is recorded in the Reference-Zone under the optimal recording condition derived in the pre-recording learning processing step A100. An area formed at that time corresponds to at least about one circle of the disc, and in a case of a disc with Land Groove structure, the recording mark is desirably produced in a series of 6 tracks including an area with the center track which is Groove and a pair of Land/Groove in the right and the left sides thereof, and an area with the center track which is Land and a pair of Groove/Land from each of the right and the left sides thereof. It is highly convenient with 6 tracks because calibration can be performed with 5 tracks recorded status on Land and Groove (more than 6 tracks does not affect reproducing characteristics). The recording condition adjustment processing step A300 has the same procedure as in the exemplary embodiments 2 and 3.

As described, the present exemplary embodiment can achieve more precise and stable calibration for the recording condition because correction selection for the Tr (track) offset is performed in the pre-recording learning, and because the Reference-Zone is formed with a similar status to the real recording.

As the above, the structures and the operations in the preferable exemplary embodiment of the present invention are explained. However, it is to be noted that these exemplary embodiments are only exemplifications of the present invention, and do not limit the present invention at all. Variable versions and changes can be acceptable depending on a specific usage without departing from the scope of the subject matter of the present invention, which will be easily understood by one skilled in the art.

### INDUSTRIAL APPLICABILITY

As described in the above, according to the present invention, a recording condition learning step can be cut in an optical disc device for recording/reproducing, and a recording condition adjustment procedure can be simplified more than the conventional one, also performed more stably and accurately.

### BRIEF DESCRIPTION OF THE DRAWINGS

FIGS. 1A, 1B, and 1C are illustrations showing examples of processing flow in a recording condition adjustment method for an information recording medium according to an exemplary embodiment 2 of the present invention;

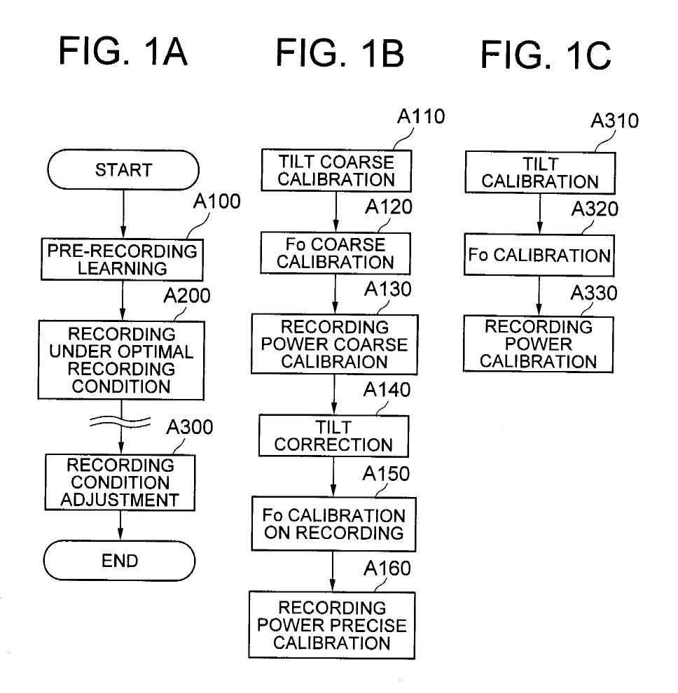

FIGS. 2A, 2B, and 2C are illustrations showing examples of processing flow in a recording condition adjustment method for an information recording medium according to an exemplary embodiment 3 of the present invention;

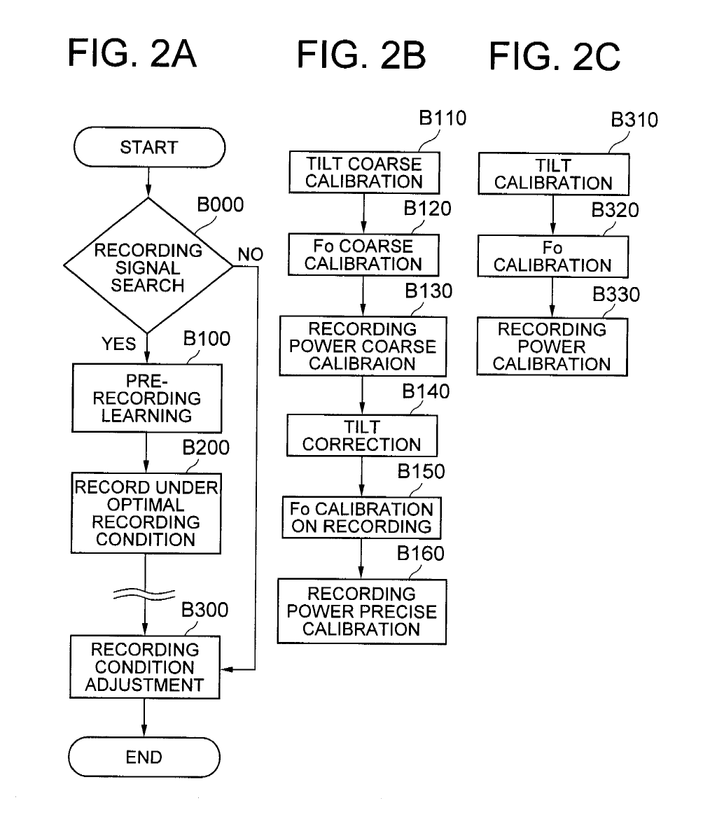

FIGS. 3A, 3B, and 3C are illustrations showing examples of processing flow in a recording condition adjustment method for an information recording medium according to an exemplary embodiment 4 of the present invention;

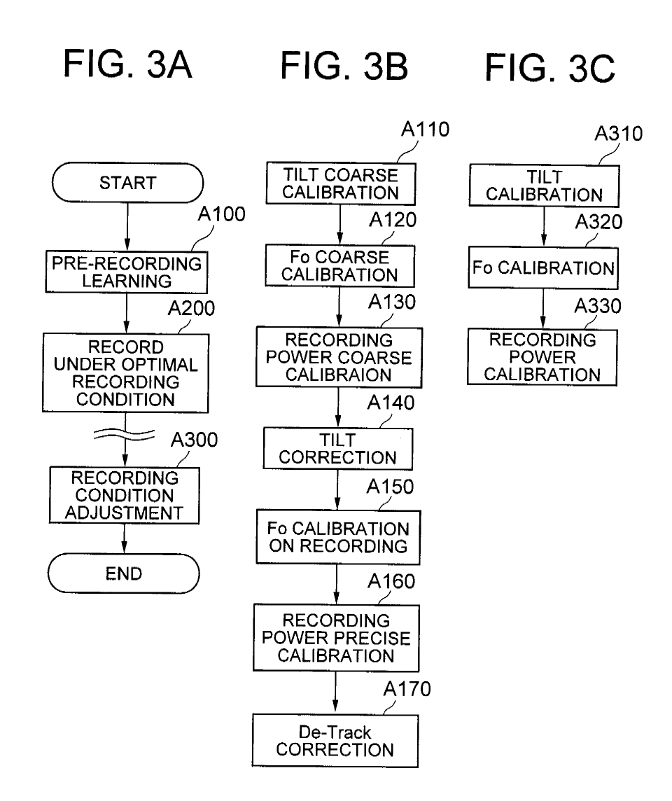

FIG. 4 is an illustration showing an error rate measuring examples based on deference in detection methods.

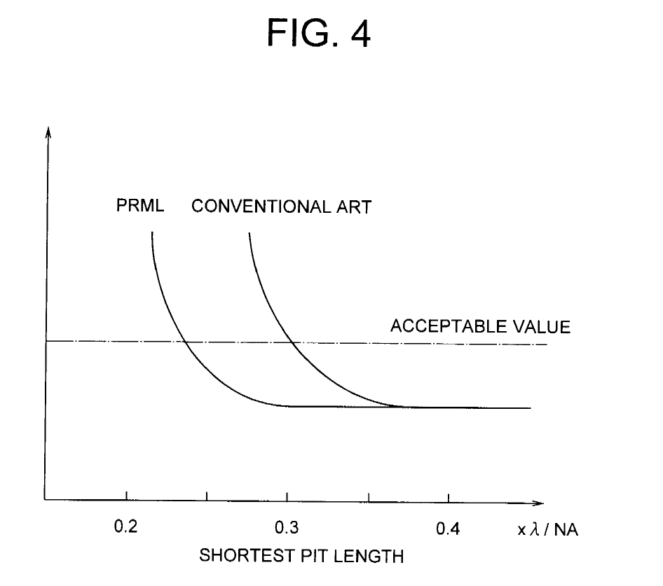

FIG. 5 is an illustration showing a positional relationship between tracks and recording marks in the information recording medium according to the exemplary embodiments of the present invention;

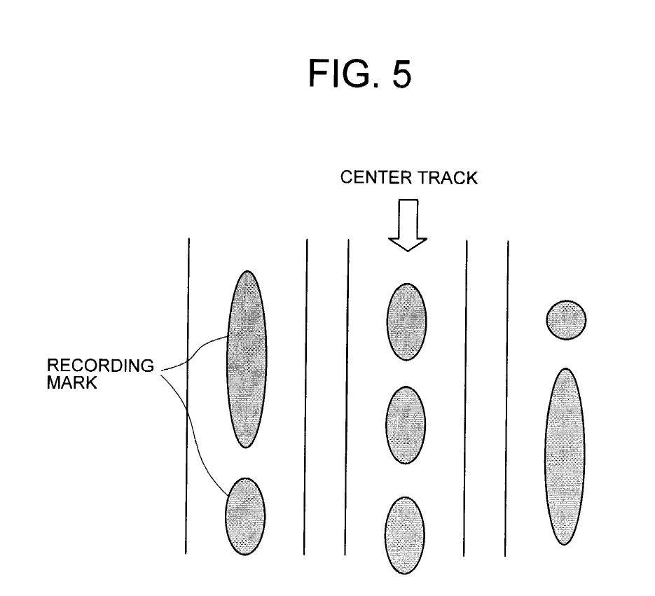

FIG. 6 is an illustration showing another example of a positional relationship between tracks and recording marks in the information recording medium according to the present invention;

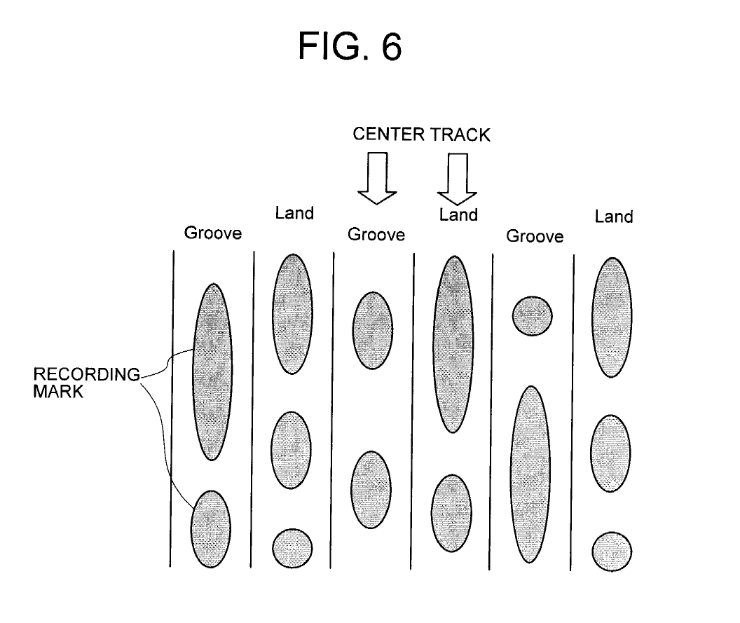

FIG. 7 is an illustration showing an example of an information recording/reproducing apparatus according to an exemplary embodiment 1 of the present invention,

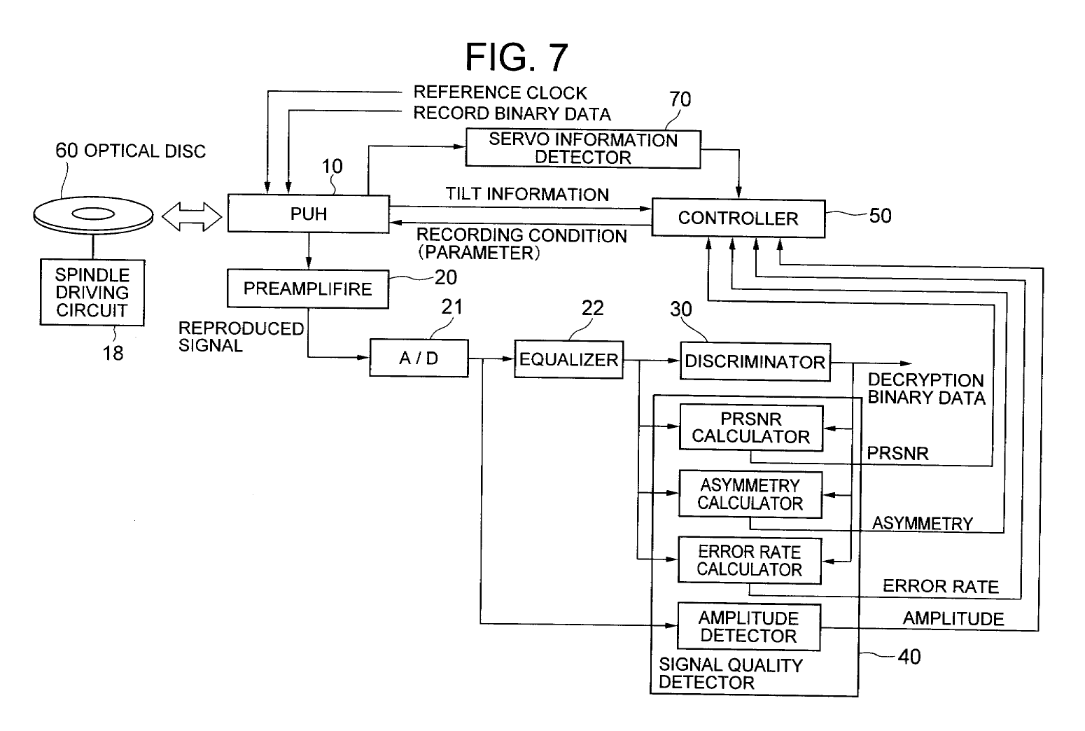

FIG. 8 is an illustration showing an example of a PUH structure in the information recording/reproducing medium according to the exemplary embodiment 1 of the present invention;

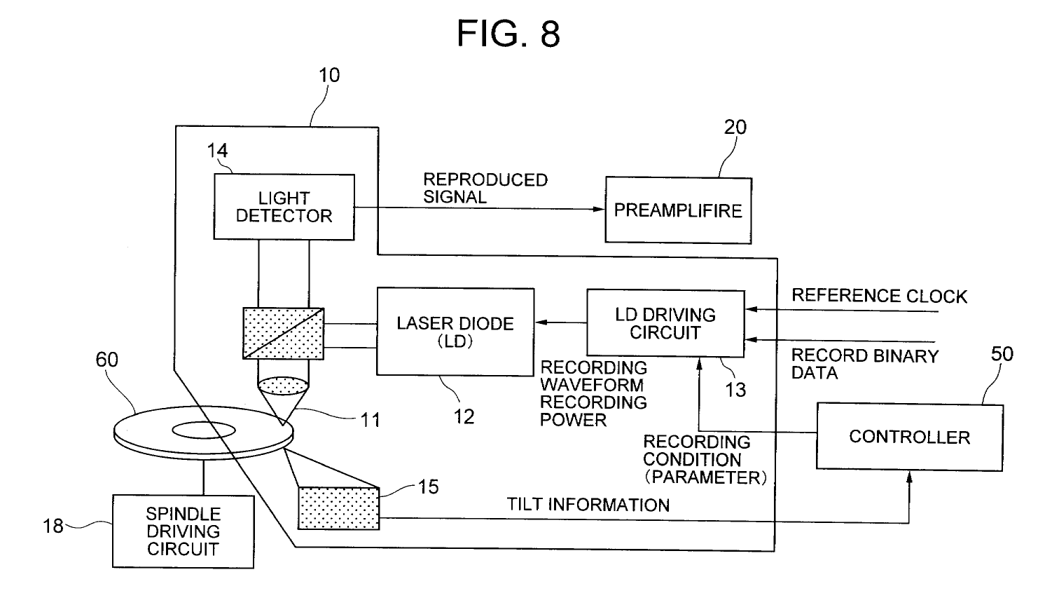

FIG. 9 is an illustration showing an example of a area structure in the information recording medium in the exemplary embodiments of the present invention;

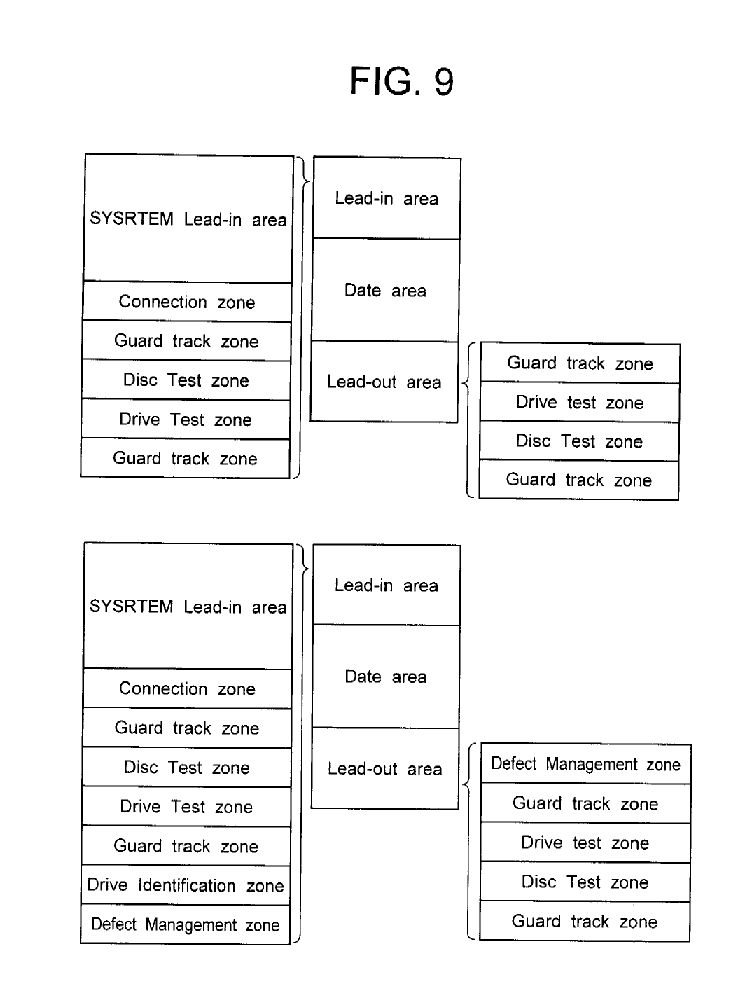

FIG. 10 is an illustration showing a measuring example in which a relationship between a servo signal amplitude and a tilt corresponds to a PRSNR; and

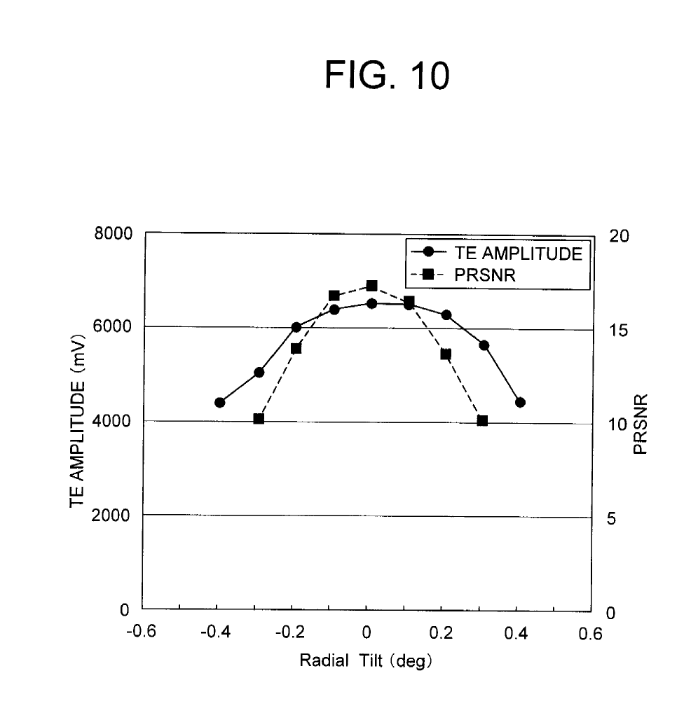

FIG. 11 is an illustration showing an example of combinations of tracking offsets according to the exemplary embodiments of the present invention.

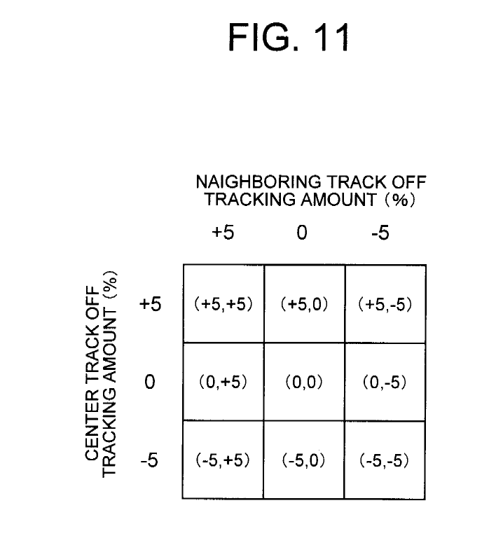

### DESCRIPTION OF THE SYMBOLS

10 PUH
11 objective lens
12 LD (laser diode)
13 LD driving circuit
14 light detector
15 tilt detector
18 spindle driving circuit
20 preamplifier
21 A/D converter
22 equalizer
30 discriminator
40 signal quality detector
50 controller
60 optical disc

1-21. (canceled)

22. A recording condition adjustment method for an information recording medium comprising:
performing a pre-recording learning for optimizing a recording condition when information is recorded on a recording medium;
recording a signal in a prescribed area of the information recording medium under the optimal recording condition determined in the pre-recording learning; and
performing an adjustment of a part of a next and later recording condition using reproducing characteristics of the signal recorded only under the optimal recording condition in recording the signal in the prescribed area of the information recording medium.

23. The recording condition adjustment method for an information recording medium, as claimed in claim 22, comprising:
searching whether there is a recorded signal in the prescribed area or not prior to the performance of the pre-recording learning, wherein the adjustment of a part of a next and later recording condition is performed if there is a recorded signal in the prescribed area, and the pre-recording learning or the recording of the signal is performed if there is no recorded signal in the prescribed area.

24. The recording condition adjustment method for an information recording medium, as claimed in claim 23, wherein the adjustment of a part of a next and later recording condition includes an adjustment of a part of the recording condition to be controlled using the recorded signal, and an adjustment of a recording condition which cannot be adjusted in the adjustment of the part of the recording condition is adjusted without using the recorded signal.

25. The recording condition adjustment method for an information recording medium, as claimed in claim 24, wherein at least one of an amplitude value, an asymmetry value, an SNR value and an error late is used for recording condition adjustment in the adjustment of the part of the recording condition as an evaluation index upon adjustment with the recorded signal read out.

26. The recording condition adjustment method for an information recording medium, as claimed in claim 22, wherein any one of a focus offset, a track offset, a tilt and an aberration is used as the recording condition.

27. The recording condition adjustment method for an information recording medium, as claimed in claim 22, wherein a part in a test area (a drive test zone or a disc identification zone) is set as the prescribed area.

28. The recording condition adjustment method for an information recording medium, as claimed in claim 22, wherein a signal recorded in the prescribed area includes information indicating that the recorded signal itself is usable for recording condition adjustment.

29. The recording condition adjustment method for an information recording medium, as claimed in claim 22, wherein the signal recorded in the prescribed area includes information indicating a drive in which the signal is recorded.

30. The recording condition adjustment method for an information recording medium, as claimed in claim 22, wherein the information recording medium has: a spiral or a concentric groove structure formed in a radial direction periodically; and a groove, a land in between the grooves, or both of them as a recording/reproducing track, wherein recording in the prescribed area is performed in a center track and at least one track each from right and left sides of the center track.

31. The recording condition adjustment method for an information recording medium, as claimed in claim 30, wherein the information recording medium is used, in which both of a groove and a land in between the grooves are included as a recording/reproducing track, and in which recording is performed to a series of 6 tracks as the recording in the prescribed area.

32. The recording condition adjustment method for an information recording medium, as claimed in claim 22, wherein a method is included in which information is recorded optically by irradiating an optical beam from a laser light source focused by an objective lens on a surface of the recording medium, reproducing the recorded signal such that a mark and a space recorded on the recording medium surface is read out as a recorded signal by a reflective light which is the optical beam irradiated on the surface of the recording medium and reflected from it, and a shortest value for an interval of polarity reversal of the recorded signal on the recording medium is smaller than 0.35*λ/NA when a laser wavelength of the light source is λ, and a numerical aperture of the objective lens is NA.

33. An information recording/reproducing apparatus for an information recording medium comprising:
a signal quality detector for estimating a reproduced signal quality from a reproduced signal;
a recording condition control section for controlling a recording condition;
a learning processing section for performing a pre-recording learning to determine an optimal recoding condition from the reproduced signal quality and the recording condition;
a recording control unit for performing a pre-recording learning to optimize a recording condition upon recording on the information recording medium, and producing a recorded signal in a prescribed location based on information obtained in the learning processing section; and
a control unit for performing a part of a next and later recording condition adjustment processing by reproducing the recorded signal produced by the recording control unit.

34. The information recording/reproducing apparatus for an information recording medium, as claimed in claim 33, comprising:
a search processing unit for searching whether there is a recorded signal or not in the prescribed area prior to the pre-recording learning and
a recording control unit for adjusting a part of the recording condition to be controlled using the recorded signal when the recorded signal is in the prescribed area, and performing the pre-recording learning processing so as to record a signal in a desired location based on information obtained by the pre-recording learning processing section when the recorded signal is not in the prescribed area.

35. The information recording/reproducing apparatus for an information recording medium, as claimed in claim 33, wherein an adjustment processing using a recorded signal produced in the prescribed area comprises a first adjustment processing for adjusting a part of the recording condition to be controlled; and a second adjustment processing for adjusting a recording condition, which cannot be adjusted by the first adjustment processing, without the recorded signal.

36. The recording/reproducing apparatus for an information recording medium, as claimed in claim 33, wherein at least one of an amplitude value, an asymmetry value, an SNR value or an error rate is used as an evaluation index upon adjustment with a recorded signal being read out in the first adjustment processing.

37. The recording/reproducing apparatus for an information recording medium, as claimed in claim 33, wherein the recording condition includes any one of a focus offset, a track offset, a tilt, and an aberration.

38. The recording/reproducing apparatus for an information recording medium, as claimed in claim 33, wherein the prescribed area is a part of a test area (a drive test zone or a disc identification zone).

39. The recording/reproducing apparatus for an information recording medium, as claimed in claim 33, wherein a signal recorded in the prescribed area includes information indicating a drive in which the signal is recorded.

40. The information/reproducing apparatus for an information recording medium, as claimed in claim 33, wherein the information recording medium has a spiral or a concentric groove structure formed in a radial direction periodically; and a groove, a land in between the grooves, or both of them is/are a recording/reproducing track; and recording in the prescribed area is the recording a center track and at least one track each from left and right sides of the center track.

41. The recording/reproducing apparatus for an information recording medium, as claimed in claim 40, wherein the information recording medium has both a groove and a land in between the grooves as a recording/reproducing track, and recording in the prescribed area is performed with respect to a series of 6 tracks.

42. The information recording/reproducing apparatus for an information recording medium, as claimed in claim 33, wherein information is recorded optically illuminating a surface of a recording medium with an optical beam from a laser light source focused by an objective lens, and the recorded signal is reproduced illuminating the recording medium surface with the optical beam, and a mark and a space recorded on the recording medium surface by an reflective light from the information medium surface are read out as a recorded signal, wherein
a shortest value for an interval of polarity reversal of a signal recorded on the recording medium is smaller than 0.35*λ/NA, when a laser wavelength of a light source is λ, and a numeric aperture of an objective lens is NA.

43. An information recording/reproducing means for an information recording medium comprising:
a signal quality detecting means for estimating a reproduced signal quality from a reproduced signal;
a recording condition control means for controlling a recording condition;
a learning processing means for performing a pre-recording learning to determine an optimal recoding condition from the reproduced signal quality and the recording condition;
a recording control means for performing a pre-recording learning to optimize a recording condition upon recording on the information recording medium, and producing a recorded signal in a prescribed location based on information obtained in the learning processing means; and
a control means for performing a part of a next and later recording condition adjustment processing by reproducing the recorded signal produced by the recording control means.
